(19) United States
(12) Patent Application Publication
(10) Pub. No.: US 2019/0281993 A1
(43) Pub. Date: Sep. 19, 2019

(54) Heat-Resistant Sleep Articles

(71) Applicant: AW Industries, Inc., Landover, MD (US)

(72) Inventor: Donald Messinese, Churchton, MD (US)

(73) Assignee: AW Industries, Inc., Landover, MD (US)

(21) Appl. No.: 16/352,089

(22) Filed: Mar. 13, 2019

Related U.S. Application Data
(60) Provisional application No. 62/642,097, filed on Mar. 13, 2018.

(51) Int. Cl. A47C 27/15

(52) U.S. Cl. CPC A47C 27/15; B32B 7/027

(57) ABSTRACT

The invention is that of heat-resistant sleep articles comprising a latex core material with polyurethane encasement. The latex core with polyurethane encasement may be incorporated into laminated sleep articles such as mattresses or used in hybrid configurations with metal innersprings and the like. The heat-resistant sleep articles described herein are designed incorporate latex core materials into articles of manufacture that meet or exceed the flammability standards administered by the United States Consumer Product Safety Commission. In one embodiment, the invention comprises a laminated inner mattress material comprising a layer of latex encased in one or more layers of protective polyurethane foam and further comprising one or more additional layers of polyurethane or polyurethane gel swirl material. In another embodiment, the polyurethane-encased latex core may be used in conjunction with a metal innerspring as an upholstery material for a hybrid mattress.

### CROSS REFERENCE TO RELATED APPLICATIONS

This application claims the benefit of the priority date of U.S. Provisional Patent Application No. 62/642,097, filed Mar. 13, 2018, the contents of which are incorporated by reference herein in their entirety.

### STATEMENT REGARDING FEDERALLY FUNDED RESEARCH

The invention described herein was developed without federal funding.

### BACKGROUND OF THE INVENTION

The United States Code of Federal Regulations 16 C.F.R. § 1632 and 1633, administered by the U.S. Consumer Product Safety Commission (CPSC), require all mattresses, mattress pads, foundations and mattress sets introduced into interstate commerce in the United States to meet flammability standards.

Latex, especially natural latex, can be used to form a cushion and is a desirable material for use in mattresses. However, latex foam materials which extend to the edges of a mattress frequently fail the tests prescribed for meeting federal flammability standard, making them unsuitable. Latex foam components of a mattress must be encapsulated at the edges and across the surface by materials that will meet or exceed the federal flammability standard for mattresses.

While nesting a latex material inside a prefabricated polyurethane foam border is a potential solution to this problem, this approach can result in bulges or gaps, leading to performance problems. The present invention was developed in order to provide a latex material encased in polyurethane material in a manner that yields the benefit of meeting the federal flammability standard while avoiding the performance problems associated with the nesting of latex core material inside of prefabricated polyurethane foam.

### SUMMARY OF THE INVENTION

Disclosed herein is a mattress, mattress pad, foundation, mattress set or other sleep product or article (collectively referred to hereinafter as “mattresses”) according to the invention of the present disclosure, comprising a latex core and a barrier material surrounding all or a portion of the latex core, rendering the mattress resistant to combustion. The barrier material comprises flame- and heat-resistant material that is configured to prevent combustion of the latex core when the upholstered article is subjected to heat or flame, for example, via the application of a flame from a gas burner.

It has been discovered that prefabricating a core material comprising a latex-based material and a barrier comprising a laminated polyurethane barrier or encasement, such as an encasement at the corners of a mattress, solves the performance problems associated with the nesting of latex core material inside of prefabricated polyurethane foam, while maintaining compliance with the federal flammability standard, whereas a mattress without such a barrier will likely fail the mattress test prescribed to evaluate compliance with the standard.

### BRIEF DESCRIPTION OF DRAWINGS

FIG. 1 shows a depiction of a laminated mattress core 100 according to one embodiment of the present disclosure, wherein the laminated mattress core 100 comprises a multilayer arrangement of latex and polyurethane comprising a polyurethane bottom layer 101, a first middle layer comprising a latex topper 102, a second (polyurethane) middle layer 103 and a polyurethane top layer 104.

FIG. 2 shows a depiction of a latex topper 102 according to one embodiment of the present invention, wherein the latex topper 102 is of rectangular shape and uniform thickness, the thickness in one embodiment in a range from 2-5 inches thick, and wherein the latex topper 102 comprises a polyurethane foam portion 202 and a latex core 201, the latex core 201 in a rectangular shape and bordered by the polyurethane foam portion 202 ranging in width from 1.5-9 inches and completely encasing the latex core 201 on all sides.

### DETAILED DESCRIPTION OF THE INVENTION

The invention of the present disclosure is that of heat-resistant sleep articles useful in producing mattresses comprising a latex foam core material and at least one laminated polyurethane foam layer encasing the latex foam core material to ensure compliance with the federal flammability standard for mattresses promulgated at 16 C.F.R. § 1633, which is incorporated herein by reference in its entirety.

The federal flammability standard requires that mattresses exhibit a peak heat release not to exceed 200 kilowatts (kW) within the 30-minute test prescribed at 16 C.F.R. § 1633.7 and a total heat release not to exceed 15 megajoules (MJ) for the first ten minutes of the test. One of ordinary skill in the art will appreciate that the exemplary cushioning properties of latex make it a suitable material for use in mattresses, and thus the low heat-resistance properties of latex have led to a need in the art for an article of manufacture that is a sleep article comprising latex, but with heat-resistance properties that meet the federal flammability standard.

Latex is a natural or synthetic material used in the manufacture of mattresses that typically ignites at around 400 degrees Fahrenheit and exhibits inconsistent federal flammability standard test results when used in mattresses. Polyurethane foam, a synthetic material that typically ignites at around 650 degrees Fahrenheit, generally melts away from the heat source and passes the prescribed flammability test. Mattresses containing latex materials may therefore comprise a polyurethane foam as a barrier between latex components and a heat source in order to improve flammability test results. If these materials are simply placed adjacent to each other, the imprecision of cutting the components to size can result in gaps between “undersized” components—creating inconsistencies in performance—or bulges from “oversized” components—also creating quality problems (lumps, bulges, etc.).

The present invention involves a novel solution to this problem: providing a laminated core of latex further comprising a polyurethane barrier to the latex component prior to assembly of the mattress, thus assuring successful flammability test results, and eliminating the quality problems resulting from inconsistencies in mattress component sizes. This is true for both foam-core mattresses, as well as “hybrid” mattresses containing both steel and foam component materials.

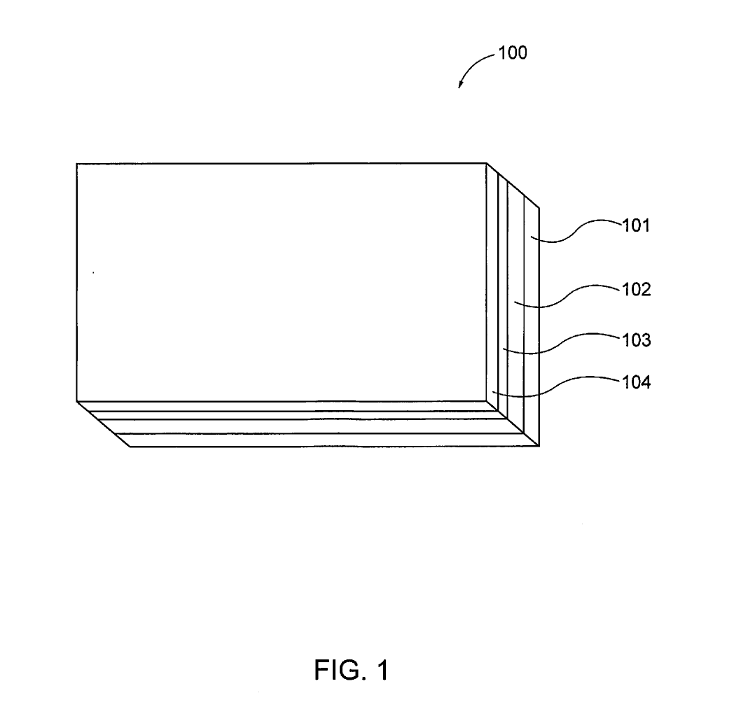

FIG. 1 is a depiction of a laminated mattress core 100 according to one embodiment of the present invention, wherein the laminated mattress core 100 comprises a multilayer arrangement of latex and polyurethane comprising a polyurethane bottom layer 101, a first middle layer comprising a latex topper 102, a second (polyurethane) middle layer 103 and a polyurethane top layer 104, the latex topper 102 comprising a latex core 201 encased in a polyurethane foam perimeter 202.

In one embodiment of the present disclosure, an assembly is provided comprising a latex topper 102 included in a foam mattress consisting of one or more layers of foam, the latex core 201 affixed (such as by glue or other adhesive) to a polyurethane foam perimeter 202, so that the latex core 201 is completely encased by the polyurethane foam perimeter 202 and therefore sequestered from, and not subject to, the flame applied during required flammability testing. The prefabrication of the latex topper 102 ensures that its outside dimensions match those of the other foam components making up the mattress core 100. Embedding the latex topper 102 between other layers of polyurethane foams that will pass the federal flammability test ensures that the entire mattress will meet the flammability standard.

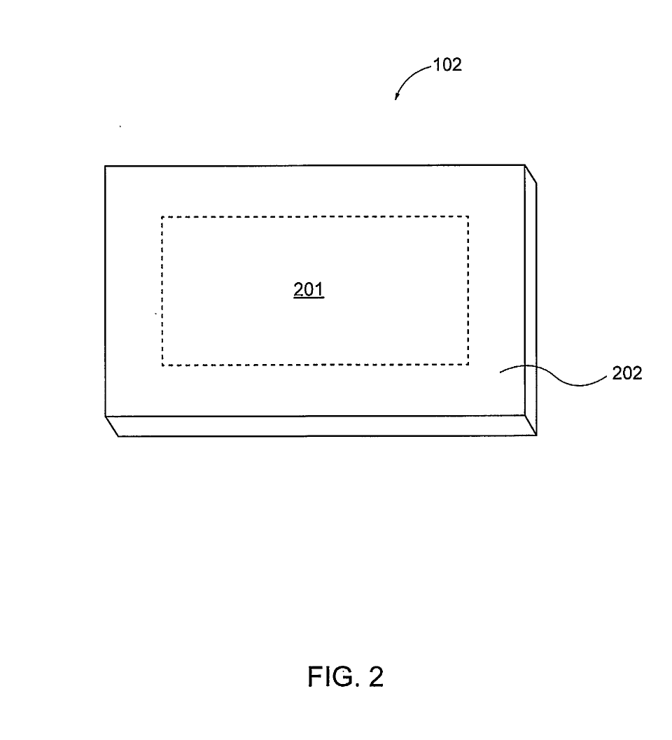

In another embodiment, an assembly is provided comprising a hybrid mattress (not shown) comprising a latex topper 102 as shown in FIG. 2 resting on a layer of innersprings and further comprising a plurality of upholstery layers and optionally one or more additional foam layers. A latex core 201 is affixed or adhered (such as by glue or other adhesive) to a polyurethane foam perimeter 202, so that the latex core 201 is sequestered from and as a result will not be subject to the flame applied during federal flammability standard testing. Here as well, prefabricating the latex topper 102 ensures that its outside dimensions match those of the innersprings and any other foam components making up the mattress. Embedding the latex topper 102 between other layers of polyurethane foams that will pass the flammability test ensures that the entire mattress will meet the flammability standard.

In certain embodiments, the latex core 201 of the present disclosure comprises latex at a density of at least 1.45 pounds per cubic foot (lbs. ft.³); at least 1.45 but not more than 5 lbs. ft.³; at least 1.5 but not more than 5 lbs. ft.³; or at least 2 but not more than 5 lbs. ft.³, in each case inclusive of all subranges. In certain embodiments, the latex core 201 of the present disclosure ranges in vertical thickness from 1.5-9 inches or 1.5-8 inches, inclusive of all subranges. One of ordinary skill in the art will understand that the density and thickness of a latex core 201 of the present disclosure may be selected from within the recited ranges and subranges based on criteria related to comfort and durability. In certain embodiments of the present disclosure, the latex core 201 is encased in a polyurethane foam perimeter 202 material that is at least 1.3 lbs. ft.³ in density and at least 2.75 but not more than 6 inches in width on each of the six sides of the latex core. One of ordinary skill in the art will appreciate the width and density of the polyurethane perimeter 202 may be selected according to criteria such as comfort and desired heat-resistance.

The invention may further comprise one or more layers of polyurethane laminated above and below the latex topper 102, each polyurethane layer of the laminate also being at least 1.3 1.3 lbs. ft.³. One of ordinary skill in the art will also appreciate that the materials of the present invention may be selected based on comfort characteristics in addition to physical characteristics such as density. For example, it is common in the art to measure the indention force deflection (“IDF”) of foams used in the construction of mattresses. The IDF is a numerical measure of firmness of a foam material, with soft materials corresponding to lower IDF values than firmer materials. In mattress construction, it may be preferable to have high-IDF materials near the vertical center of the mattress, with low-IDF materials near the mattress surface, where more softness may be desired by a person lying on the mattress. One of ordinary skill in the art will appreciate that the foam densities and IDFs may be selectively combined to produce a sleep article of the present invention based on various performance criteria. One of ordinary skill in the art will also appreciate that gel swirl polyurethanes may be used in the laminated articles of manufacture described herein.

In certain embodiments of the present disclosure, the latex core 201 has an IDF ranging from 14 to 28, inclusive. In these and other embodiments of the present disclosure, the laminated mattress core 100 comprises at least two and preferably three or more polyurethane foam layers with IDFs ranging from 6 to 9, inclusive. In these embodiments of the present disclosure, the flame- or heat-resistant mattress described herein comprises at least one latex foam component and at least one polyurethane foam material applied to or encasing a portion of the latex foam component, the laminated polyurethane encasement surrounding the latex foam component to render the resulting assembly flame retardant as measured by the federal flammability standard test. In one embodiment, a laminated polyurethane perimeter encasing the latex component of a mattress provides for a mattress material assembly that releases not more than 200 kW during a 30-minute test and a total heat release not exceeding 15 MJ during the first ten minutes of the test, the 30-minute test being carried out according to the testing procedure as provided at 16 C.F.R. § 1633.7. In another embodiment, a flame- and heat-resistant barrier layer or material is provided that is capable of maintaining its flame- and heat-resistant integrity after being exposed to a flame for three minutes in accordance with small-scale flame- and heat-resistant barrier tests. Table 1 contains example data from flammability tests conducted in accordance with 16 C.F.R. § 1633.7 on various prototypes of the invention of the present disclosure.

The invention of the present disclosure is suitable for the use in the manufacture of mattresses of standard size, such as twin (˜38×75 inches), full (˜54×75 inches), queen (˜60×80 inches) and king (˜76×80 inches), as well as European or other international counterparts.

In another embodiment, a method of manufacture of a flame-retardant mattress comprises prefabricating a latex core 201 material with a protective laminated polyurethane foam perimeter 202 and assembling the prefabricated laminated latex layer together with one or more mattress components, wherein the components may comprise one or more material layers or spring layers.

It will be clear to one of ordinary skill in the art that features disclosed in relation to any of the embodiments disclosed above can be applicable interchangeably between the different embodiments. The embodiments disclosed above are examples to illustrate various features of the invention.

TABLE 1

| | | | | | Time to | Total |
|---|---|---|---|---|---|---|
| | | | | Peak 30 Min. | Peak | Heat |
| | | | | Heat | Heat | Released |
| Test | Test | | | Release | Release | @ 10 Min. |
| No. | Code | Sample ID | Prototype ID | (kW) | (min) | (MJ) |
| 1 | 10301702 | ML1 Encapsulated | ML1 Encapsulated | 34 | 1.7 | 6.8 |
| | | Latex Topper Set | Latex Topper Set | | | |
| | | Sample 1 | | | | |
| 2 | 10301703 | ML1 Encapsulated | ML1 Encapsulated | 26 | 1.6 | 4.1 |
| | | Latex Topper Set | Latex Topper Set | | | |
| | | Sample 2 | | | | |
| 3 | 10301704 | ML1 Encapsulated | ML1 Encapsulated | 26 | 1.5 | 4.5 |
| | | Latex Topper Set | Latex Topper Set | | | |
| | | Sample 3 | | | | |
| 4 | 10301705 | ML2 Encapsulated | ML2 Encapsulated | 52 | 22.9 | 7.1 |
| | | Latex Topper Set | Latex Topper Set | | | |
| | | Sample 1 | | | | |
| 5 | 10301706 | ML2 Encapsulated | ML2 Encapsulated | 66 | 25.9 | 7.5 |
| | | Latex Topper Set | Latex Topper Set | | | |
| | | Sample 2 | | | | |
| 6 | 10301707 | ML2 Encapsulated | ML2 Encapsulated | 72 | 28.1 | 8.4 |
| | | Latex Topper Set | Latex Topper Set | | | |
| | | Sample 3 | | | | |
| 7 | 10301708 | ML1 Encapsulated | ML1 Encapsulated | 29 | 1.5 | 5.4 |
| | | Latex Topper Mat | Latex Topper Mat | | | |
| | | Only Sample 1 | Only | | | |
| 8 | 10301709 | ML1 Encapsulated | ML1 Encapsulated | 26 | 1.7 | 4.2 |
| | | Latex Topper Mat | Latex Topper Mat | | | |
| | | Only Sample 2 | Only | | | |
| 9 | 10301710 | ML1 Encapsulated | ML1 Encapsulated | 29 | 1.6 | 4.6 |
| | | Latex Topper Mat | Latex Topper Mat | | | |
| | | Only Sample 3 | Only | | | |
| 10 | 10301711 | ML2 Encapsulated | ML2 Encapsulated | 24 | 1.7 | 4.0 |
| | | Latex Topper Mat | Latex Topper Mat | | | |
| | | Only Sample 1 | Only | | | |
| 11 | 10301712 | ML2 Encapsulated | ML2 Encapsulated | 32 | 1.6 | 5.4 |
| | | Latex Topper Mat | Latex Topper Mat | | | |
| | | Only Sample 2 | Only | | | |
| 12 | 10301713 | ML2 Encapsulated | ML2 Encapsulated | 31 | 1.6 | 4.9 |
| | | Latex Topper Mat | Latex Topper Mat | | | |
| | | Only Sample 3 | Only | | | |

Features, characteristics, compounds, chemical moieties or groups described in conjunction with a particular aspect, embodiment or example of the invention are to be understood to be applicable to any other aspect, embodiment or example described herein unless incompatible therewith. All the features disclosed in this disclosure, and all of the steps of any method or process so disclosed, may be combined in any combination, except combinations where at least some of such features or steps are mutually exclusive.

What is claimed is:

1. A heat-resistant mattress having a laminated mattress core comprising:
a polyurethane bottom layer;
at least one middle layer positioned above the bottom layer, wherein the at least one middle layer comprises a latex topper and optionally a polyurethane middle layer; and
a polyurethane top layer positioned above the at least one middle layer, wherein;
the latex topper comprises a latex core encased by a polyurethane foam perimeter; and
wherein the latex layer is not exposed to flame when a flame source is applied to the heat-resistant mattress.

2. The heat-resistant mattress of claim 1, wherein the latex core has a vertical thickness of at least 2.75 inches.

3. The heat-resistant mattress of claim 2, wherein the latex core has a vertical thickness of not more than 6 inches.

4. The heat-resistant mattress of claim 1, wherein the polyurethane foam perimeter has a thickness of at least 1.5 inches.

5. The heat-resistant mattress of claim 4, wherein the polyurethane foam perimeter has a thickness of not more than 9 inches.

6. The heat-resistant mattress of claim 1, wherein the latex core has a density of at least 1.45 lbs. ft³.

7. The heat-resistant mattress of claim 6, wherein the latex core has a density of not more than 5 lbs. ft³.

8. The heat-resistant mattress of claim 1, wherein the polyurethane foam perimeter has a density of at least 1.3 lbs. ft³.

9. The heat-resistant mattress of claim 1, wherein the latex core has an IDF of at least 14.

10. The heat-resistant mattress of claim 9, wherein the latex core has an IDF of not more than 28.

11. The heat-resistant mattress of claim 1, wherein the polyurethane bottom layer, polyurethane middle layer and polyurethane top layer have an IDF of at least 6.

12. The heat-resistant mattress of claim 11, wherein the polyurethane bottom layer, polyurethane middle layer and polyurethane top layer have an IDF of not more than 9.

13. The heat-resistant mattress of claim 1, wherein the polyurethane bottom layer, polyurethane middle layer and polyurethane top layer comprise a polyurethane swirl, gel swirl, gel foam, memory foam or any combination thereof.

14. A heat-resistant mattress having a hybrid mattress core comprising:
at least one innerspring; and
at least one latex topper positioned above the at least one innerspring, wherein the latex topper comprises a latex core encased by a polyurethane foam perimeter; and
wherein the latex layer is not exposed to flame when a flame source is applied to the heat-resistant mattress.

15. The heat-resistant mattress of claim 14, wherein the latex core has a vertical thickness of at least 2.75.

16. The heat-resistant mattress of claim 14, wherein the polyurethane foam perimeter has a thickness of at least 1.5.

17. The heat-resistant mattress of claim 14, wherein the latex core has a density of at least 1.45.

18. The heat-resistant mattress of claim 14, wherein the polyurethane foam perimeter has a density of at least 1.3 lbs. ft³.

19. The heat-resistant mattress of claim 14, wherein the latex core has an IDF of at least 14.

20. (canceled)

21. The heat-resistant mattress of claim 15, wherein the latex core has a vertical thickness of not more than 6 inches.

22. The heat-resistant mattress of claim 16, wherein the polyurethane foam perimeter has a thickness of not more than 9 inches.

23. The heat-resistant mattress of claim 17, wherein the latex core has a density of not more than 5 lbs. ft³.

24. The heat-resistant mattress of claim 19, wherein the latex core has an IDF of not more than 28.

25. A heat-resistant mattress of claim 1, wherein the peak heat release does not exceed 200 kW during the 30-minute test set forth in 16 C.F.R. § 1633.7 and the total heat release does not exceed 15 MJ for the first 10 minutes of the test when the heat-resistant mattress is subjected to the test.

26. A heat-resistant mattress of claim 14, wherein the peak heat release does not exceed 200 kW during the 30-minute test set forth in 16 C.F.R. § 1633.7 and the total heat release does not exceed 15 MJ for the first 10 minutes of the test when the heat-resistant mattress is subjected to the test.
